(19) United States
(12) Patent Application Publication
(10) Pub. No.: US 2019/0036267 A1
(43) Pub. Date: Jan. 31, 2019

(54) Housing with Lid for Cable Lug

(71) Applicant: Auto-Kabel Management GmbH, Hausen i.W. (DE)

(72) Inventors: Andreas Lienert, Wegberg-Arsbeck (DE); Amir Attarzadeh, Mönchengladbach (DE); Ralf Bodem, Meerbusch (DE)

(21) Appl. No.: 16/074,546

(22) PCT Filed: Dec. 22, 2016
(86) PCT No.: PCT/EP2016/082311

§ 371 Date: Aug. 1, 2018

(30) Foreign Application Priority Data
Mar. 8, 2016 (DE) 10 2016 104 140.8

(51) Int. Cl. H01R 13/506; H01R 13/52

(52) U.S. Cl. CPC H01R 13/506; H01R 13/5202

(57) ABSTRACT

Housing with a base body open to one side with four outer walls and a base, at least two cable infeeds and a lid with an inside and an outside. Good cable sealing is achieved in that the lid has a groove with a groove base and two groove webs delimiting the groove on its inside such that the outer edges of the outer walls located at the open side are received in the groove in the connected state between lid and base body such that at least one of the groove webs is elastically deformed and thus acts in a sealing manner with respect to the outer walls.

The subject matter relates to a housing with a base body open to one side with four outer walls and a base, at least two cable entries and a lid with an inside and an outside.

Electric cabling is relevant to security in the field of automotive engineering. Since vehicles are generally exposed to changeable environmental conditions, such as rain, splash water, road salt, strong temperature fluctuations and the like, electric connections are always sources of fault with respect to corrosion. In particular in the case of battery lines, which are permanently connected to the battery plus potential, contact corrosion can be promoted by the voltage applied to the line.

Connections between two electric lines are generally implemented via a cable lug and corresponding screw connections. In this case, it is important that the connection point is protected against penetrating moisture. This is nowadays generally implemented by shrink tubing which is laid over the connection point and then shrunk. Such shrink tubing is, however, problematic with respect to longitudinal water which creeps between the shrink tubing and cable insulation. Complete sealing is difficult to achieve here.

In particular in the case of battery cables or other high-voltage applications in the automotive industry, the so-called wading depth is also a relevant criterion. Vehicles can only be submerged in water up to a certain depth. This depth is called the wading depth and is also determined by the position of electric lines and the battery. Laying battery lines under the floor leads to the wading depth of vehicles being very small. There is, in particular, the risk that they can permanently sustain damage when electric lines laid under the floor are submerged in water.

For this reason, the object underlying the invention was to protect the connection between two electric lines inside a vehicle from moisture.

This object is achieved by a housing according to claim 1.

It has been found that sufficient protection can be ensured against penetrating water by a housing surrounding the connection point having a corresponding lid. This is achieved in that a groove is present on a lid inside. The groove is delimited outwards by two groove webs. The distance of the groove webs, in particular, generally corresponds roughly to the material thickness of the outer walls of the base body. The groove preferably runs circumferentially around the lid.

As soon as the lid is placed on the base body, it can lock with the base body, as will be described below. In a connected state, the outer edges of the outer walls located at the open side are received in the groove. Upon being received, they can be elastically deformed by a suitable configuration of the groove webs and thus cause sealing with respect to the outer walls.

The outer walls penetrate into the groove by way of the placement of the lid on the base body. In this case, the groove webs, but at least one of the groove webs, is/are elastically deformed outwards from the interior of the groove. The forces occurring in doing so act towards the outer walls and lead to sealing. The lid thus seals the base body in a water-tight manner.

According to one embodiment, it is proposed for the material thickness of the groove webs to be different to one another. The inner groove web can, in particular, be wider than the outer groove web. However, it is also possible for the outer groove web to be wider than the inner groove web. The different material thicknesses of the groove webs preferably causes the respectively thinner groove web to be elastically deformed to a greater extent than the respectively wider groove web. If the outer groove web is thinner than the inner groove web, the elastic deformation firstly preferably takes place at the outer groove web such that it already causes a sealing at the outer walls.

An inner groove web is the groove web which is facing the centre of the lid, whereas an outer groove web is the groove web which is facing away from the centre of the lid.

According to one embodiment, it is proposed for an inner groove web at the inside of the lid inclined inwards to protrude from the inside. The inside of the lid is the side that has the groove. The lid is, in particular, placed with its inside on the base body. On the one hand, the placing of the groove on the outer edge is facilitated by a slight incline of the inner groove web inwards and, on the other hand, the sealing is improved.

The improvement of the receiving of the outer edge in the groove is also facilitated by an outer groove web at the inside of the lid inclined outwards protruding from the inside. The groove webs respectively protrude from the inside. However, it has been found that it may be advantageous for the groove webs to protrude from the inside diverging from one another, in particular protruding from the inside in a v-shape. This enormously facilitates the receiving of the outer edges when the base body is combined with the lid. The elastic deformation is also influenced such that the best possible sealing is achieved.

In order to arrange the lid securely on the base body, the lid is preferably locked with the base body in the connected state. To this end, indentations or detent catches respectively pointing in the direction of the groove can be provided on the groove webs. Corresponding thereto, a corresponding indentation or a corresponding recess can respectively be provided on the outer walls of the base body. They are preferably circumferential corresponding to the indentations or detent catches on the groove webs. It is also possible for a thread to be provided on the groove webs which corresponds to a thread on the base body.

It is particularly advantageous when the inner groove web has an indentation or a detent catch on its side pointing outwards. Indentations or projections provided on the inside of the outer walls can interact therewith such that the lid locks in the base body or the outer surfaces of the base body in the connected state.

The elastic deformation of the groove webs means that sufficient sealing is ensured between base body and lid. This means that the lid and the base body can be formed from the same material which is different to known solutions. The material of the lid and of the base body are, in particular, a plastic, in particular PVC, PE, PC or PET.

Electric components are always exposed to high temperature fluctuations in automotive applications. The required elasticity to seal the lid must be ensured by the material in a temperature range of preferably −30 degrees Celsius to +180 degrees Celsius. The material of the lid and base body is, in this case, preferably temperature-resistant up to 180 degrees Celsius.

The sealing by the objective lid is splash-proof up to a water pressure of 80 bar. This water-tightness is also preferably achieved with temperatures of approx. 80° C.

According to one embodiment, it is proposed for the lid to be formed in one piece together with its groove webs. The lid can, in particular, be an injection-moulded part.

According to one embodiment, it is proposed for the lid to be in contact with the outer edge and the outer wall at three inner surfaces of the groove in the region of the groove. The shape of the groove is designed such that in the connected state, both preferably the groove base and the two groove webs are in contact with the outer edge or the outer wall such that sealing takes place at three contact surfaces between lid and base body. Particularly good water-tightness is hereby achieved.

According to one embodiment, it is proposed for a preferably circumferential sealing strip to be provided in the groove base. The sealing strip is preferably made of a different material to the lid. The sealing strip is, in particular, manufactured together with the lid in an injection-moulding process. The sealing strip and the lid are preferably manufactured in a 2-component (2-c) injection mould. The sealing strip is preferably formed from a silicone. The lid is preferably made of a hard material and the sealing strip of a soft material. The E modules of hard material and sealing strip are, in particular, different from one another.

According to one embodiment, it is proposed for a receptacle for a cable lug to be arranged in the base body. The cable lug can be arranged on this receptacle and preferably be screwed with a second cable lug such that an electric connection can be established between two cables in the housing.

The cables are led into the housing preferably via cable sleeves. The cable sleeves are sealed at the cable entries.

According to one embodiment, it is proposed for two cable lugs to be screwed together in the housing.

The subject matter will be explained in more detail below based on a drawing showing exemplary embodiments. In the drawing:

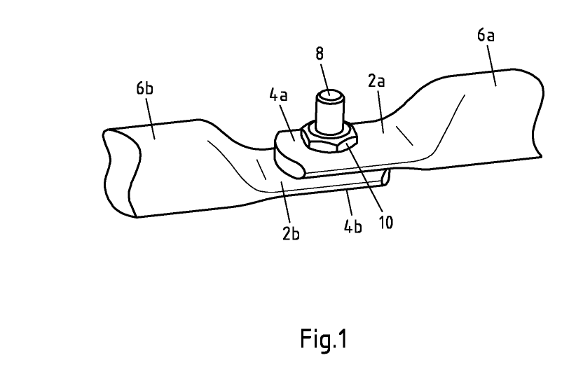

FIG. 1 shows a schematic view of a connection between two cable lugs;

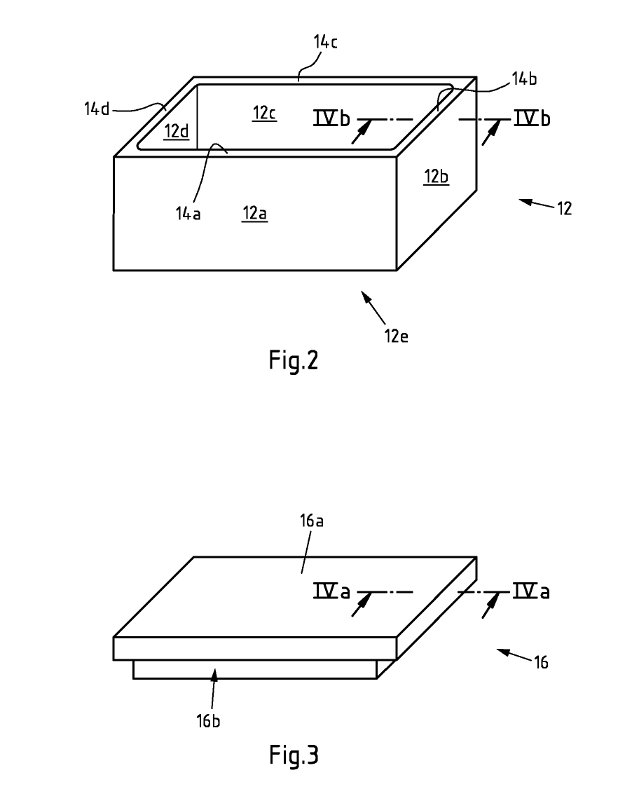

FIG. 2 shows a schematic view of a base body;

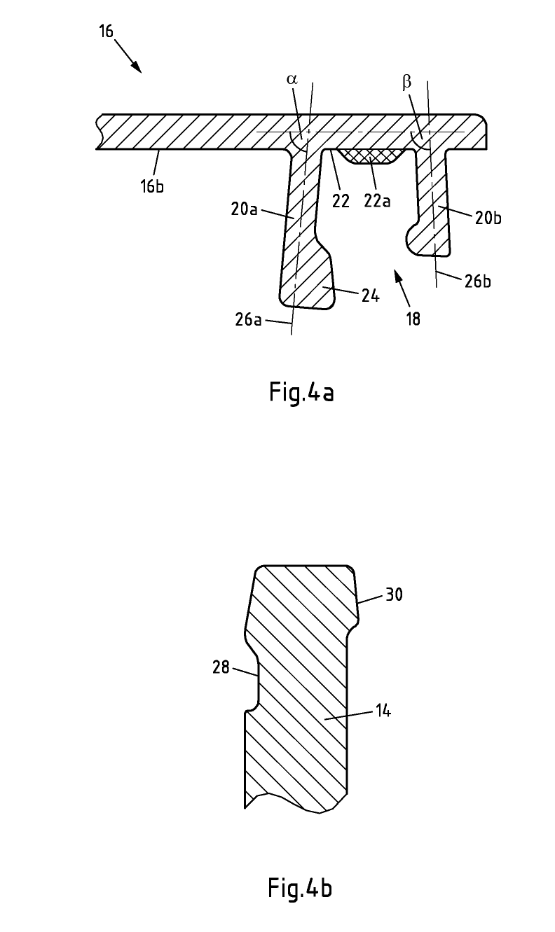

FIG. 3 shows a schematic view of a lid;

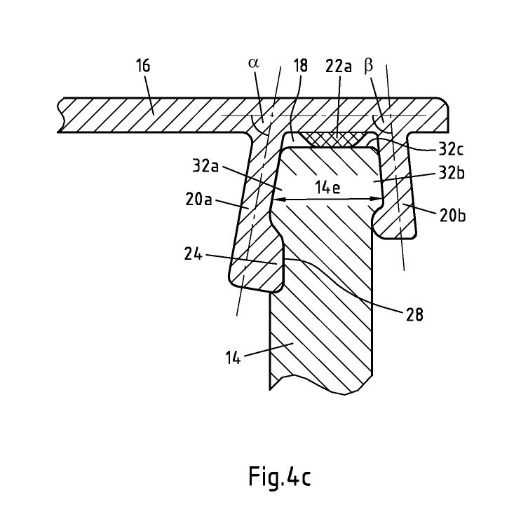

FIG. 4a shows a sectional view through a lid in the region of a groove;

FIG. 4b shows a sectional view of an outer wall in the region of an outer edge of the base body;

FIG. 4c shows a sectional view of a lid with a base body in the connected state.

FIG. 1 shows a first cable lug 2a and a second cable lug 2b. The first cable lug 2a is preferably provided with a through-hole in the region of a flattened portion 4a. A preferably round electric cable 6a is connected in the first cable lug 2a.

The second cable lug 2b has a threaded bolt 8 in the region of its flattened portion 4b.

The second cable lug 2b is also electrically connected to an electric cable 6b. The first cable lug 2a is screwed to the second cable lug 2b via a screw connection by means of a screw 10 along the threaded bolt 8 and an electric connection is established between the cable lugs.

It is understood that the electric connection shown is purely as an example and any other electric connection between two electric cables 6a, 6b is also included. Such electric connections are problematic since insulation must be broken at the connection point. However, there is always the risk of corrosion in the region of this broken insulation.

For this reason, an electric connection, as is shown by way of example in FIG. 1, must be protected against corrosion. To this end, a base body and a lid, as described below, are proposed.

FIG. 2 shows a base body 12 of a housing. The base body 12 has four outer walls 12a-d and a base 12e. The base body is, in particular, formed in one piece. The base body is preferably formed from an injection-moulded plastic. The outer walls 12a-d seal the outer edges 14a-d.

A lid 16 has an outside 16a and an inside 16b. The inside 16b is facing the base body 12 in the connected state. A groove is provided circumferentially around the lid 16, as is shown in FIG. 4a.

FIG. 4a shows a cut in the region of an outer edge of the lid 16. It can be discerned in FIG. 4a that a groove 18 is provided on the inside 16b of the lid 16. The groove 18 has a first groove web 20a and a second groove web 20b. The first groove web 20a is on the interior side of the lid 16, i.e. it is facing the centre of the lid 16 and the second groove web 20b is on the exterior side of the lid 16, i.e. facing the centre of the lid 16.

The lid 16 can seal with the outer groove web 20b, but a lining can also be provided.

A groove base 22 is provided in the groove 18. A projection 22a is provided at the groove base 22. The projection 22a is preferably formed from a material strengthening of the lid 16.

The projection 22a can be provided as a seal circumferentially in the groove base 22. The projection 22a is preferably formed from another, preferably softer material than the lid 16 or the groove webs 20a, 20b. The material of the projection 22a is, in particular, cast together with the material of the lid in a 2-c injection-moulding process. The material of the projection 22a is preferably a silicone. The material of the lid is preferably formed from a thermoplastic, in particular polybutylene terephthalate (PBT).

A detent catch 24 is provided on a longitudinal end of the groove web 20a. The detent catch 24 is formed pointing outwards from the centre of the lid 16.

It can also be discerned that the groove web 20a is inclined with its longitudinal axis 26a by the angle α in the direction of the centre of the lid 16. The groove web 20b is inclined outwards at the other side along its longitudinal axis 26b by the angle β with respect to the plane of the lid 16.

The outer edges 14 are formed corresponding to the groove 18, as shown in FIG. 4b. An indentation 28 is provided in the region of the longitudinal end of the outer edge 14 which corresponds to the detent catch 24. A projection 30 is also provided at which the outer groove web 20b comes into contact.

In the connected state, as is represented in FIG. 4c, the outer edge 14 is locked in the groove 18. In this case, the dimensioning of the distance between the groove webs 20a, 20b is selected in relation to the width 14e of the outer edge 14 such that the groove webs 20a, 20b are elastically deformed outwards in the connected state. In this case, the angles α and β are reduced.

The groove web 20a is pressed in the direction of the centre of the lid 16 by the elastic deformation of the groove webs 20a, 20b and the outer groove web 20b is pressed away from the centre of the lid 16.

A force hereby results through the groove webs 20a, 20b which acts on the outer surface of the outer edge 14. As a result, it arrives at contact surfaces 32a and 32b. The groove web 20a abuts the inside of the outer edge 14 at the contact surface 32a.

The outer groove web 20b abuts the outer surface of the outer edge 14 at the contact point 32b, which is in the region of the projection 30.

The detent catch 24 also engages behind the indentation 28 in the connected state such that the lid 16 is held securely on the base body 12. Additionally, a pressing force is effected along the longitudinal axis of the outer edge 14 in the direction of the projection 22a by the locking of the detent catch 24 in the indentation 28 such that a contact surface 32c is also formed here between lid 16 and outer edge 14.

Sealing is effected at three points between the lid and outer edge by the contact surfaces 32a-c such that the housing is well protected against penetrating water.

### LIST OF REFERENCE NUMERALS

2a, b Cable lug
4a, b Flattened portion
6a, b Cable
8 Threaded bolt
10 Screw
12 Base body
12a-d Outer walls
14 Outer edges
16 Lid
16a Outside
16b Inside
18 Groove
20a, b Groove web
22 Groove base
22a Projection
24 Detent catch
26a, b Longitudinal axis
28 Indentation
30 Projection
32a-c Contact surfaces

1-13. (canceled)

14. A housing comprising:
a base body open to one side with four outer walls and a base;
at least two cable infeeds; and
a lid with an inside and an outside, the lid having, on its inside, a groove with a groove base and two groove webs delimiting the groove such that the outer edges of the outer walls are received in the groove in a connected state between lid and base body, such that at least one of the groove webs is elastically deformed and thus acts in a sealing manner with respect to the outer walls, and
wherein the lid is, in the connected state, in contact with the outer edge and the outer wall at three inner surfaces of the groove in the region of the groove.

15. The housing according to claim 14, wherein the two groove webs comprise an inner groove web on the inside of the lid that is wider than an outer groove web.

16. The housing according to claim 15, wherein the inner groove web is inclined inwards and protrudes from the inside.

17. The housing according to claim 14, wherein one of the two groove webs comprises an outer groove web on the inside of the lid inclined outwards and protruding from the inside.

18. The housing according to claim 14, wherein one of the two groove webs comprises an inner groove web on the inside of the lid having an indentation and/or a locking tab at its side pointing outwards.

19. The housing according to claim 14, wherein the lid and the base body are formed from the same material, in particular in that the material is a plastic, in particular PVC, PE, PC, PBT or PET.

20. The housing according to claim 14, wherein the material of the lid and/or base body is temperature-resistant up to 180° C.

21. The housing according to claim 14, wherein the lid is formed in one piece together with its groove webs.

22. The housing according to claim 14, further comprising a receptacle, for a cable lug, arranged in the base body.

23. The housing according to claim 14, wherein the cable infeeds are formed as cable sleeves.

24. The housing according to claim 14, further comprising two cable lugs screwed together in the housing.

25. A lid for use with a housing having a base body open to one side with four outer walls and a base and at least two cable infeeds, the lid comprising:
a lid member with an inside and an outside;
a groove, on the inside, with a groove base and two groove webs delimiting the groove so that the outer edges of the outer walls are received in the groove in a connected state between lid and base body such that at least one of the groove webs is elastically deformed and thus acts in a sealing manner with respect to the outer walls.
